(19) United States
(12) Patent Application Publication
(10) Pub. No.: US 2007/0200541 A1
(43) Pub. Date: Aug. 30, 2007

(54) Control Circuit Of Switching Regulator, And Power Source Device And Electronic Device Using The Control Circuit

(75) Inventor: Shogo Hachiya, Fukuoka (JP)

Correspondence Address: CANTOR COLBURN, LLP, 55 GRIFFIN ROAD SOUTH, BLOOMFIELD, CT, 06002, US

(73) Assignee: ROHM CO., LTD., KYOTO (JP)

(21) Appl. No.: 11/659,612

(22) PCT Filed: Jul. 22, 2005
(86) PCT No.: PCT/JP05/13474

§ 371 Date: Feb. 6, 2007

(30) Foreign Application Priority Data
Aug. 6, 2004 (JP) 2004-230676

(51) Int. Cl. G05F 1/00

(52) U.S. Cl. 323/282

(57) ABSTRACT

A switching regulator is provided which allows a switching to an optimum control method according to a set on which it is to be mounted. A power supply apparatus, which is a step-down type DC-DC converter, includes two blocks, namely a control circuit and a switching regulator. The switching regulator includes a switching transistor, a rectifier diode, in inductor and a capacitor. The control circuit generates a drive signal that controls the on and off of the switching transistor. The control circuit includes a fixed frequency control signal generation unit, a fixed ON-time control signal generation unit, a driver circuit and an inverter. Either one of the fixed frequency control signal generation unit and a fixed ON-time control signal generation unit operates according to a selection signal inputted to a selection terminal from the outside, and the other is shut down.

### BACKGROUND OF THE INVENTION

1. Field of the Invention

The present invention relates to an power supply apparatus, and it particularly relates to a switching regulator.

2. Description of the Related Art

Inside a variety of electronic devices, step-up type and step-down type DC-DC converters, such as switching regulators, are widely used to supply proper voltage to electronic circuits used therein. Switching regulators like these have a control circuit that generates switching control signals for controlling the ON and OFF of the switching element.

As for such switching control signals, PWM methods, in which the frequency is constant and the switching element is turned on and off according to the pulse width, are widely used, and the following two methods are known. In the first method, the output voltage is monitored, and the durations of ON and OFF of the switching control signal are determined by comparing the output voltage and the reference voltage. In the second method, the output voltage and the output current are monitored at the same time, the durations of ON and OFF of the switching control signal are determined by comparing the reference voltage and the output voltage, and further the changes in output current are reflected in the ON and OFF durations (hereinafter referred to as current mode control). These techniques are described in Patent Documents 1 and 2, for instance. Hereinbelow, the control system using switching signals with constant frequency is referred to as the fixed frequency method.

In such a fixed frequency method, however, the period from an ON of the switching element to the next ON thereof is fixed at a cycle time which is given by the reciprocal of the switching frequency, and therefore it has the problem of its inability to follow up the load variation or input voltage variation faster than the switching frequency and the resulting instability of output.

Thus, a conceivable method to meet applications that require high-speed load response is one that fixes the pulse width, namely, the ON period Ton, of the switching control signal and changes the frequency of the high level (hereinafter referred to as fixed ON-time method). According to this fixed ON-time method, more high-speed response to load variation or input voltage variation can be achieved than the fixed frequency method.

[Patent Document 1]

Japanese Patent Application Laid-Open No. 2003-219638.

[Patent Document 2]

Japanese Patent Application Laid-Open No. 2003-319643.

It is to be noted that electromagnetic waves are generated from these switching regulators, and therefore EMI (ElectroMagnetic Interference) specifications must be met when they are to be mounted in a set. Concerning the above-mentioned fixed frequency method and fixed ON-time method, whereas switching control signals are generated at a constant frequency in the fixed frequency method, it has been necessary to take EMI measures in consideration of wider frequency band in the fixed ON-time method where the frequency changes with load variation and input voltage variation.

It is often the case that the users of switching regulators, namely, set makers and the like, desire the use of switching regulators of the fixed ON-time method capable of high-speed response once the EMI specifications are met. However, the EMI has the problem that whether the specifications are met or not cannot be determined until the parts are mounted on a set and measurements are taken while actually operating the set. Thus, if the specifications are not met as a result of EMI measurements after designing a board for a switching regulator using a fixed ON-time method, then it will be necessary to take a costly measure, such as providing a shield again, or design a board again to replace it by a switching regulator using a fixed frequency method, thus posing a problem of obstructing the efficiency of set design.

In view of not only EMI as described above but also power conversion efficiency and the like, it will contribute significantly to the convenience of the users if the switching control method can be switched.

### SUMMARY OF THE INVENTION

The present invention has been made in view of the foregoing problems, and a general purpose thereof is to provide a switching regulator that allows a switching to an optimum control method according to a set on which it is to be mounted.

One embodiment of the present invention relates to a control circuit for a switching regulator. This control circuit controls a switching element in the switching regulator, by a plurality of different control methods that allow a switching from outside.

According to this embodiment, the method for controlling the switching regulator can be switched to a suitable mode in accordance with characteristics required of the switching regulator or a state of electronic equipment on which a switching regulator is mounted.

Another embodiment of the present invention relates also to a control circuit for a switching regulator. This control circuit comprises: a first control signal generation unit and a second control signal generation unit which each generates a switching control signal for controlling a switching element in the switching regulator; and a driver circuit, connected between output terminals of the first and the second control signal generation unit and the switching element to be controlled, which drives the switching element based on the switching control signal generated by either selected one of the first control signal generation unit and the second control signal generation unit.

According to this embodiment, it can be switched to an optimum control method depending on the characteristic required by the switching regulator. The driver circuit, which is comprised of a transistor that occupies a large area, is shared by the first control signal generation unit and the second control signal generation unit, thus attempting to save the area of the control circuit as much as possible.

The first control signal generation unit, the second control signal generation unit and the driver circuit may be integrated in a package. The integration of these circuit blocks makes it possible to put the circuits such as a reference voltage source used in each circuit block and the input/output pins to a common use, thus further attempting to reduce the area.

The first control signal generation unit may generate a switching control signal of which frequency is fixed and a duty ratio of ON and OFF durations varies, and the second control signal generation signal unit may fix an ON duration and vary the frequency.

The switching control signal generate by the first control signal generation unit is used as a signal that facilitates an EMI measure, whereas the switching control signal generated by the second control signal generation unit is used as a signal that excels in load response. This suitably satisfies the characteristics required of the switching regulator for each electronic equipment on which it is mounted.

The control circuit may further comprise a selection terminal, wherein either the first control signal generation unit or the second signal generation unit may be selected based on a selection signal inputted externally to the selection terminal.

The switching control method employed by the control circuit is selected from the side of electronic equipment mounted on the selection terminal, so that the control method can be optimally selected to suit the characteristics required by the electronic equipment.

The control circuit may further comprise a latch circuit which fixes the selection signal inputted to the selection terminal, wherein either one of the first control signal generation unit and the second control signal generation unit may be used fixedly until when a switching operation of the switching element is stopped. The state of selection is fixed during the switching operation, so that the stabilized switching operation can be achieved in the event that the selection signal varies.

Still another embodiment of the present invention relates to a power supply apparatus. This apparatus comprises: a switching regulator which converts an input voltage to a desired output voltage wherein the switching regulator includes a switching element; and an above-described control circuit which controls a switching operation of the switching element. The control method of inhibiting the switching by the control circuit is selectable, so that the characteristics suited for the electronic equipment to be mounted can be obtained.

It is to be noted that any arbitrary combination of the aforementioned constituent elements and the expression of the present invention changed among a method, an apparatus, a system and so forth are also effective as the embodiments of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a structure of a power supply apparatus according to an embodiment of the present invention.

FIG. 2 is a circuit diagram showing a fixed frequency control signal generation unit.

FIG. 3 is a chart showing voltage and current time waveforms of a fixed frequency control signal generation unit.

FIG. 4 is a circuit diagram showing a structure of a fixed ON-time control signal generation unit.

FIG. 5 is a chart showing voltage waveforms of a fixed ON-time control signal generation unit.

FIG. 6 shows a structure of an electronic computer that implements a power supply apparatus.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

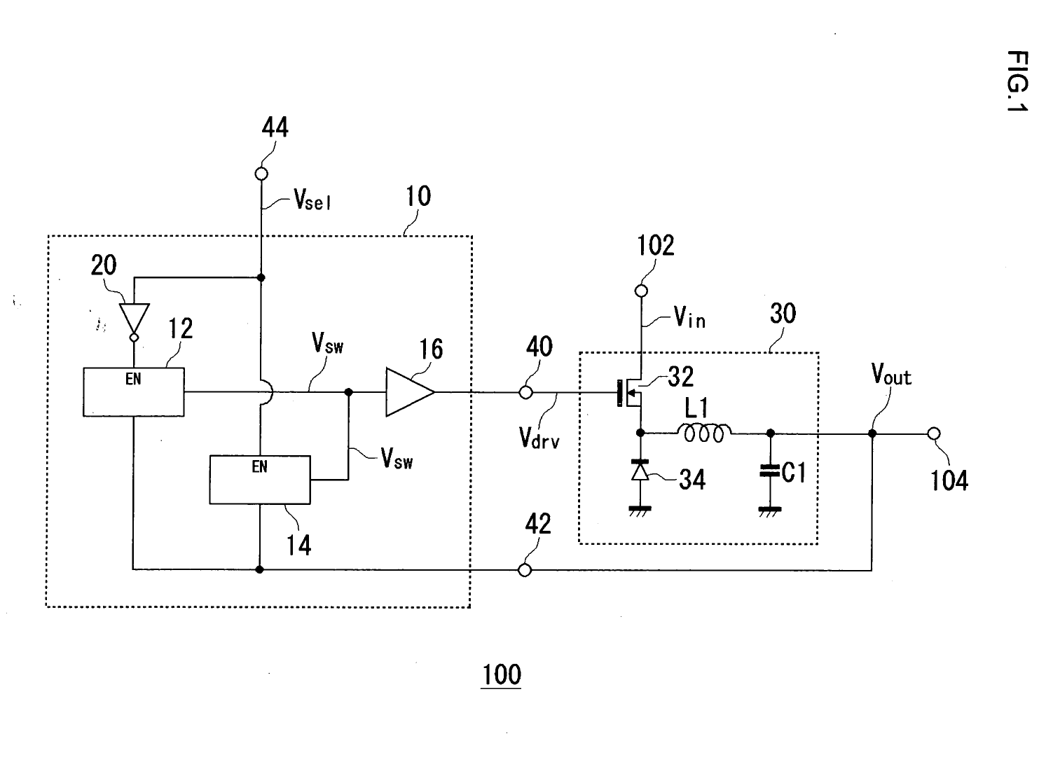

FIG. 1 shows a structure of a power supply apparatus 100 according to an embodiment of the present invention. In the subsequent figures, the same components as those in FIG. 1 will be denoted with the same reference numerals, and the description thereof will be omitted as appropriate.

The power supply apparatus 100 according to the present embodiment is a DC-DC converter which comprises two blocks, namely, a control circuit 10 and a switching regulator 30. This power supply apparatus 100 is provided with an input terminal 102 and an output terminal 104, and the voltages applied to or appearing at these terminals are called the input voltage Vin and the output voltage Vout, respectively. The power supply apparatus 100 steps down the input voltage Vin inputted to the input terminal 102 and outputs the output voltage Vout to the output terminal 104.

The switching regulator 30 includes a switching transistor 32, a rectifier diode 34, an inductor L1 and a capacitor C1.

The switching transistor 32, which is an N-type MOSFET (Metal Oxide Semiconductor Field Effect Transistor), functions as a switching element that is turned on and off by a voltage applied to the gate terminal. In this switching transistor 32, the drain terminal thereof is connected to the input terminal 102, and through an on-off operation, a current is supplied to the inductor L1 from either the switching transistor 32 or the rectifier diode 34, so that the input voltage Vin is stepped down. Also, the inductor L1 and the capacitor C1 constitute a low-pass filter so as to smooth the output voltage Vout.

The control circuit 10 outputs a drive signal Vdrv for controlling the switching operation to the gate terminal of the switching transistor 32. The drive signal Vdrv is a signal of which the high level and the low level are repeated alternately, and the ON and the OFF time of the switching transistor 32 are controlled according to the high level period and the low level period, thus driving the switching regulator 30.

The control circuit 10 includes a fixed frequency control signal generation unit 12, a fixed ON-time control signal generation unit 14, a driver circuit 16, and an inverter 20. Also, the control circuit 10 is provided with a switching terminal 40, a feedback terminal 42, and a selection terminal 44.

The output voltage Vout of the switching regulator 30 is fed back to the feedback terminal 42 of the control circuit 10. The fed-back output voltage Vout is inputted to each of the fixed frequency control signal generation unit 12 and the fixed ON-time control signal generation unit 14.

The fixed frequency control signal generation unit 12 and the fixed ON-time control signal generation unit 14 are each provided with an enable terminal EN, and each of the control signal generation units outputs a switching control signal Vsw when a high level is inputted and stops the output of the switching control signal Vsw when a low level is inputted. A selection signal Vsel, which is inverted by the inverter 20, is inputted to the enable terminal of the fixed frequency control signal generation unit 12. Thus, a switching control signal Vsw is outputted from either of the fixed frequency control signal generation unit 12 and the fixed ON-time control signal generation unit 14 according to the selection signal Vsel inputted to the selection terminal 44.

The fixed frequency control signal generation unit 12 generates a switching control signal Vsw, of which the high level period, namely, the ON period Ton, changes and the cycle time Tp, namely, the switching frequency fsw, is constant. The cycle time Tp of the switching control signal Vsw is given by Tp=Ton+Toff, using the ON period Ton and the OFF period Toff. For the fixed frequency type, the switching frequency fsw(=1/Tp) of the switching control signal Vsw is kept constant.

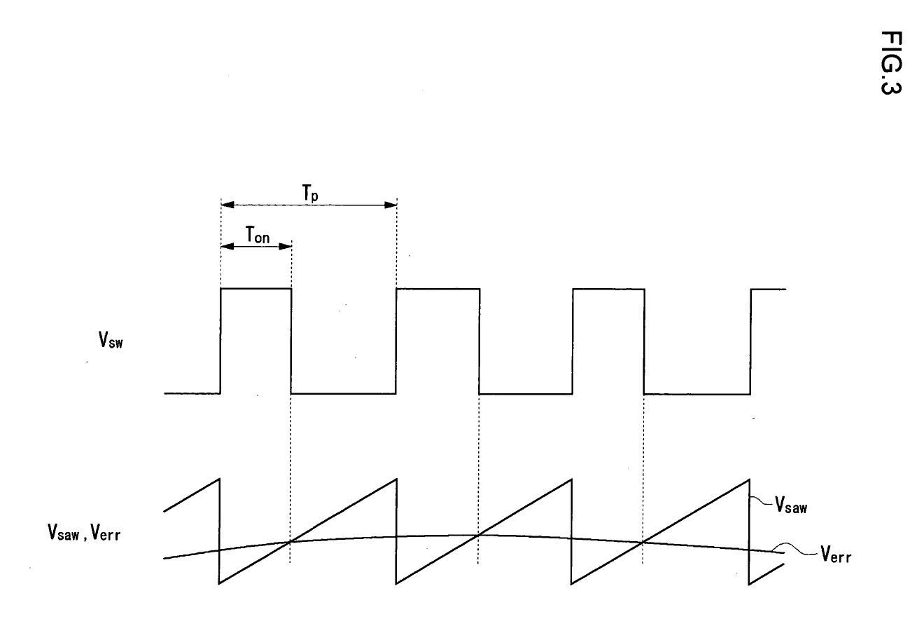

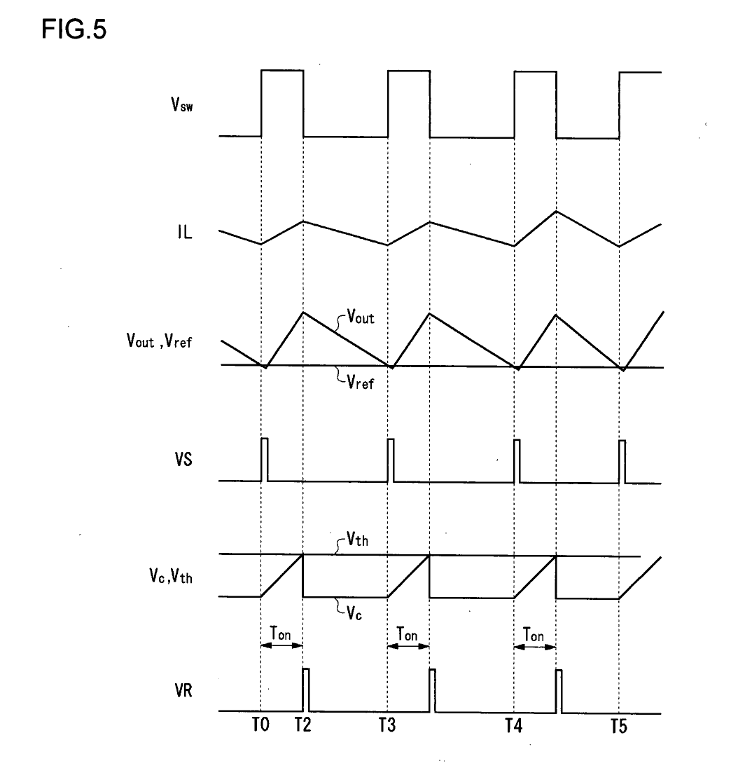

On the other hand, the fixed ON-time control signal generation unit 14 generates a switching control signal Vsw, of which the high level period, namely, the ON period Ton, is constant and the switching frequency 1/Tp changes. FIG. 3 and FIG. 5 to be described in the following show the time waveforms of the switching control signal of the fixed frequency type and that of the fixed ON-time type, respectively. For the ease of understanding, these time waveform charts give representations different from actual values for both the time axis and the voltage/current axis.

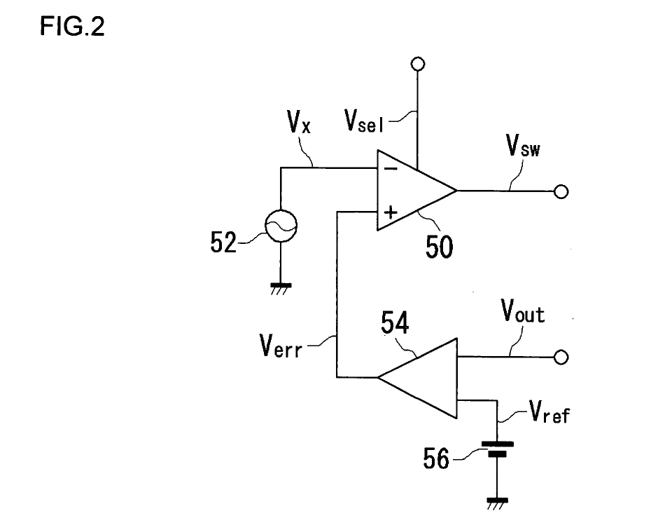

A switching control signal Vsw of the fixed frequency type as shown in FIG. 3 is generated, for instance, by a fixed frequency control signal generation unit 12 which includes a voltage comparator 50, a sawtooth oscillator 52, and error amplifier 54, and a reference voltage source 56 as shown in FIG. 2.

The error amplifier 54 compares an output voltage Vout against a reference voltage Vref generated by the reference voltage source 56 and outputs an error signal Verr by amplifying the difference. Note that the comparison against the reference voltage Vref may also be made after the output voltage Vout is resistance-divided by the error amplifier 54.

The sawtooth oscillator 52 generates a sawtooth-waveformed voltage Vsaw at a constant switching frequency fsw of 1/Tp. The voltage comparator 50 compares a sawtooth-waveformed voltage Vsaw against an error signal Verr outputted from the error amplifier 54 and outputs a high level when Verr>Vsaw and a low level when Verr<Vsaw. As a result, the output of the voltage comparator 50, namely, the switching control signal Vsw of the fixed frequency control signal generation unit 12 becomes a pulse-width-modulated signal of which the ON period Ton changes within a constant cycle time Tp as shown in FIG. 3.

It is to be noted that a signal from the enable terminal EN is inputted to the voltage comparator 50, and the arrangement is such that a switching control signal Vsw is outputted when this signal is at high level and the output of the switching control signal Vsw is stopped when it is at low level.

In this manner, generated from the fixed frequency control signal generation unit 12 is a signal wherein the switching frequency is locked to the oscillation frequency fsw of the sawtooth oscillator 52 and the ON period Ton changes. The feedback of the ON period Ton of this switching control signal Vsw is performed in such a manner that the error signal Verr, which is the output of the error amplifier 54, approaches 0 (zero), and thus the output voltage Vout is adjusted and stabilized in such a way as to approach the reference voltage Vref.

In addition to this, a fixed frequency control signal generation unit 12 may, for instance, be structured with a generation circuit of a PWM signal using a flip-flop. And this fixed frequency control signal generation unit 12 may also monitor the output current of a power supply apparatus 100 and perform a current mode control. Also, stopping the output of the switching control signal by a signal inputted to the enable terminal EN may be carried out by a variety of methods, such as providing a switch.

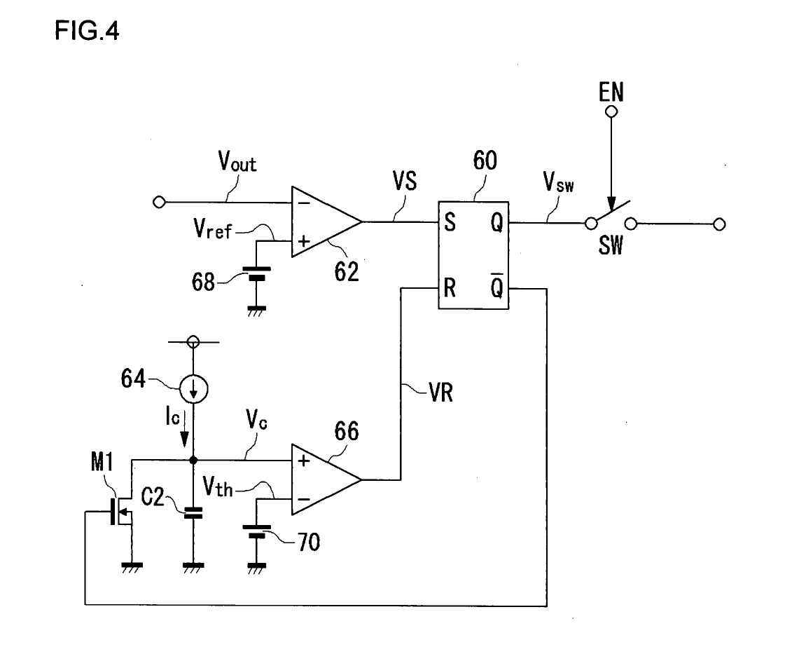

FIG. 4 shows a structure of a fixed ON-time control signal generation unit 14. And FIG. 5 shows the voltage and current waveforms at the different parts of this fixed ON-time control signal generation unit 14.

The fixed ON-time control signal generation unit 14 includes a flip-flop 60, a first voltage comparator 62, a constant current source 64, a second voltage comparator 66, a reference voltage source 68, a threshold voltage source 70, a capacitor C2, a discharge transistor M1 and a switch SW. It is to be noted that the reference voltage source 68 and the threshold voltage source 70 may be shared by the reference voltage source 56 of the fixed frequency control signal generation unit 12 by adjusting the output of a bandgap circuit to a desired level through resistance division.

As the switch SW turns on when the signal inputted from the enable terminal EN is at high level or turns off when it is at low level, a switching control signal Vsw is outputted from the fixed ON-time control signal generation unit 14 or the output is stopped.

The first voltage comparator 62 compares an output voltage Vout and a reference voltage Vref and supplies the comparison output as a set signal VS to the set terminal of the flip-flop 60.

The constant current source 64, the capacitor C2, the threshold voltage source 70, and the second voltage comparator 66 constitute a timer circuit. An inverted output of the flip-flop 60 is connected to the gate terminal of the discharge transistor M1, and during the period when this inverted output is at high level, the current Ic of the constant current source 64 flows through the discharge transistor M1 and therefore the capacitor C2 is not charged. Now, if the inverted output of the flip-flop 60 goes to low level and the discharge transistor M1 turns off, then the capacitor C2 will be charged by the constant current source 64 and the voltage Vc of the capacitor C2 will rise. As the voltage Vc reaches a threshold voltage Vth generated by the threshold voltage source 70, the output of the second voltage comparator 66 will be at high level. In other words, this timer circuit counts the ON period Ton, which is given be Ton=C2/Ic×Vref, from the time when the inverted output of the flip-flop reaches low level. Note that this ON period Ton adjusts the values of C2, Ic, and Vref in such a manner that Vin/Vout=Ton/(Ton+Toff) holds, by using the input voltage Vin of the power supply apparatus 100 and Vref, which is equivalent to a desired output voltage.

A description will be given of an operation of the fixed ON-time control signal generation unit 14 by referring to FIG. 5. Before the time T0 in FIG. 5, the switching control signal Vsw, which is the output of the flip-flop 60, is at low level, so that the timer circuit does not operate and the voltage Vc of the capacitor C2 is 0V. During this time, the switching control signal Vsw remains at low level, so that the switching transistor 32 of the power supply apparatus 100 turns off and the output voltage Vout decreases gradually.

When Vout<Vref at time T0, a high level is inputted to the set terminal and the output Vsw of the flip-flop 60 goes to high level. As a result, the switching transistor 32 of the power supply apparatus 100 turns on and the output voltage Vout begins rising. At time T0, the inverted output of the flip-flop goes to low level, and the timer circuit begins time measurement from time T0.

At time T1 after a lapse of fixed ON period Ton from time T0, the timer circuit resets the flip-flop 60, thereby bringing the switching control signal Vsw down to low level. As the switching transistor 32 turns off again, the output voltage Vout begins lowering, and at time T3, Vout<Vref again and the set signal VS of the flip-flop 60 goes to high level.

By repeating the operation like this, the fixed ON-time control signal generation unit 14 generates a switching signal that repeats ON and OFF.

When the output current IL is constant, the switching frequency takes a fixed value, but if the output current IL increases and the output voltage Vout lowers as at time T4, the cycle time Tp until time T5, when Vout<Vref the next time, will be shorter, so that the ON period Ton will remain fixed and the switching frequency will change.

The switching control signal Vsw of the fixed ON-time control signal generation unit 14 generated as described above is a signal of which the ON period Ton is constant and the cycle time Tp changes according to the output voltage Vout. Hence, when the output voltage Vout drops due to a variation in load current, the switching transistor 32 can be turned on immediately without waiting for the cycle time Tp, which makes this a switching control signal excelling in load response.

The switching control signals Vsw generated by the fixed frequency control signal generation unit 12 and the fixed ON-time control signal generation unit 14 are inputted to the driver circuit 16. The driver circuit 16 generates a drive signal Vdrv for driving the switching transistor 32, based on either of the switching control signals Vsw.

According to this power supply apparatus 100, a switching control system excelling in load response and a switching control signal facilitating an EMI measure can be used by switching between the two control methods by a single control circuit.

Note that the arrangement may be such that a latch circuit is connected to a selection terminal 44 and thereby a selection signal Vsel inputted to the selection terminal 44 is fixed by the latch circuit during the period from the start of switching operation by the power supply apparatus 100 to the stop thereof. The provision of a latch circuit can prevent any halfway switching of control systems even when there is variation in the selection signal Vsel during switching operation, thus stabilizing the power supply apparatus 100.

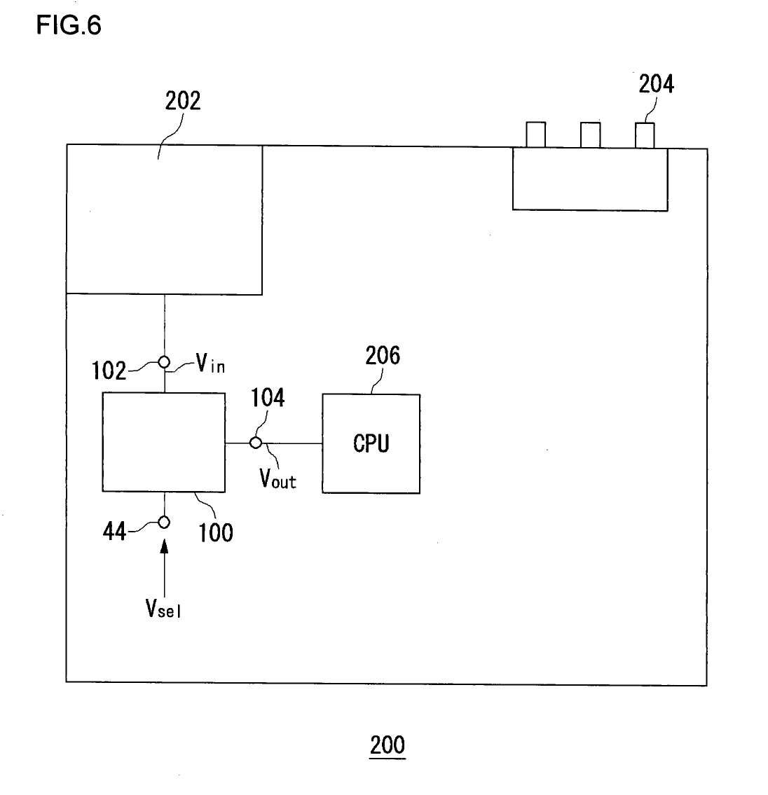

Next, a description will be given of a case where a power supply apparatus 100 structured as described above is used suitably. FIG. 6 shows a structure of an electronic computer 200, which is an electronic equipment incorporating the power supply apparatus 100. The electronic computer 200 includes a power supply unit 202, an input-output interface 204, and a central processing unit CPU 206.

The power supply apparatus 100 has a voltage of 20 V supplied from a set applied to the input terminal 102 thereof, and output terminal 104 thereof is connected to the CPU 206. The arithmetic processing circuit, such as the CPU 206, has the operating current changed according to the type of processing by the electronic computer 200. For example, the current consumption of the CPU 206 changes greatly from when a word processor application is executed to when a game software requiring much computation is run. The power supply apparatus 100 that supplies voltage to this CPU 206 must assure stable output even when the current consumption of the CPU 206, namely, the load current, changes suddenly. In such a case, it is preferable that a fixed ON-time type switching control featuring excellent load response be employed for the power supply apparatus 100.

Yet, if the electronic computer 200 does not satisfy the EMI specifications when a fixed ON-time type switching control is performed, then it will be necessary, for instance, to provide a shield around the power supply apparatus 100. As mentioned above, when a fixed ON-time type switching control is performed, the switching frequency changes according to the load current, so that the EMI measure such as above is not easy and the cost may sometimes be high. Also, since the power supply apparatus 100 is provided in the proximity of the input-output interface 204, there may be cases where it is impossible to provide a shield physically.

In such a case, it is made easy to take an EMI measure because the switching frequency is fixed by switching the switching control method to the fixed frequency type by a selection signal Vsel inputted to the selection terminal 44 without changing the board design of the electronic computer 200. The stability of the output voltage Vout at this time may be improved somewhat by adding the capacitance of the capacitor C1 of the switching regulator 30.

In other words, by employing a power supply apparatus 100 according to the present embodiment, the use of a fixed ON-time system, which excels in load response, is presupposed in designing a set, and it will be used as it is if no particular problem arises. Also, when a problem of EMI or the like has arisen in a test at the trial manufacture of a set, the problem of EMI can be addressed simply by switching the selection signal Vsel by switching to the fixed frequency method without redesigning the set board.

As described above, a shared use of the input-output terminal can be realized by integrating in a package the control circuit that can drive the switching regulator in different switching control methods, and thus it is no longer necessary to change the footprint of the printed circuit board when changing the switching control method as in the conventional practice.

The externally attached parts of the inductor L1 and the capacitor C1 can be put to shared use because the center frequencies of the switching frequency of the switching control methods are nearly equal. If the driver circuit and the reference voltage source, which occupy a large area in the control circuit 10, are shared by the fixed frequency control signal generation unit 12 and the fixed ON-time control signal generation unit 14, then it is possible to realize a circuit area not so different from that of a conventional control circuit or power supply apparatus that has only one control signal generation unit. Since the feedback terminal of the output voltage Vout and the like can also be shared, the increase in the number of pins is limited to the selection terminal 44.

Since the design architecture for similar products can be shared in the stage of product development, the development period can be shortened and the development cost can be reduced.

The embodiments are merely exemplary, and it is understood by those skilled in the art that various modifications to the combination of each component and process thereof are possible and that such modifications are also within the scope of the present invention.

In the present embodiment, the elements constituting a power supply apparatus 100 may all be integrated in a package, and some of them may be constituted by discrete parts. There may be cases where the control circuit 10 is formed as a single IC circuit and the switching transistor 32 is constituted by a discrete part or cases where the control circuit 10 and the switching transistor 32 are integrated in a package, so that which parts and the extent of their integration may be determined in consideration of the cost, the area to be occupied, and the like.

The method for the switching signal by the different control signal generation units incorporated in the control circuit 10 may be any method other than those explained in the embodiment, such as a current mode. It is preferable that the different control methods are such methods as have complementary characteristics that are in a trade-off relationship with each other. That is, in the present embodiments, EMI and load response are in a trade-off relationship, but, in addition to that, the relation may be between the power conversion efficiency and load response, or the like.

The description of the embodiment has been given, using an electronic computer as an example of an electronic equipment incorporating the power supply apparatus 100, but the scope of the present invention is not limited thereto; the embodiments may be widely applied to electronic equipment using a switching regulator, such as mobile-phone terminals, PDAs, and CD players.

While the preferred embodiments of the present invention have been described using specific terms, such description is for illustrative purposes only, and it is to be understood that changes and variations may be made without departing from the spirit or scope of the appended claims.

1. A control circuit characterized in that a switching element in a switching regulator is controlled by a plurality of different control methods that allow a switching from outside.

2. A control circuit comprising:
a first control signal generation unit and a second control signal generation unit which each generates a switching control signal for controlling a switching element in a switching regulator; and
a driver circuit, connected between output terminals of said first and said second control signal generation unit and the switching element to be controlled, which drives the switching element based on the switching control signal generated by either selected one of said first control signal generation unit and said second control signal generation unit.

3. A control circuit according to claim 2, wherein said first control signal generation unit, said second control signal generation unit and said driver circuit are integrated in a package.

4. A control circuit according to claim 2, wherein said first control signal generation unit generates a switching control signal of which frequency is fixed and a duty ratio of ON and OFF durations varies, and said second control signal generation signal unit fixes an ON duration and varies the frequency.

5. A control circuit according to claim 2, further comprising a selection terminal, wherein either said first control signal generation unit or said second signal generation unit is selected based on a selection signal inputted externally to said selection terminal.

6. A control circuit according to claim 5, further comprising a latch circuit which fixes the selection signal inputted to said selection terminal, wherein either one of said first control signal generation unit and said second control signal generation unit is used fixedly until when a switching operation of the switching element is stopped.

7. A power supply apparatus, comprising:
a switching regulator which converts an input voltage to a desired output voltage wherein said switching regulator includes a switching element; and
a control circuit, according to claim 1, which controls the switching element.

8. Electronic equipment characterized in that it includes a power supply apparatus according to claim 7.

9. A power supply apparatus, comprising:
a switching regulator which converts an input voltage to a desired output voltage wherein said switching regulator includes a switching element; and
a control circuit, according to claim 2, which controls the switching element.

10. Electronic equipment characterized in that it includes a power supply apparatus according to claim 8.
